(19) United States
(12) Patent Application Publication
(10) Pub. No.: US 2012/0129366 A1
(43) Pub. Date: May 24, 2012

(54) ELECTRICAL DEVICE

(76) Inventors: Jean-Paul COSTA, Domdidier (CH); Thomas STAEUBLI, Zurich (CH)

(21) Appl. No.: 13/296,625

(22) Filed: Nov. 15, 2011

(30) Foreign Application Priority Data
Nov. 23, 2010 (EP) 10192156.7

(51) Int. Cl. H01R 4/24; H01R 13/00

(52) U.S. Cl. 439/110; 439/391; 439/411

(57) ABSTRACT

The electrical device (10) is configured to be connected electrically to external wires (3), which are enclosed by an insulation material (2). The electrical device includes internal terminals for being connected to the wires (3) and pins (20) for piercing the insulation material (2) and contacting the wires (3). The pins (20) are arranged movably (19) in relation to the internal terminals of the electrical device (10).

### FIELD OF THE INVENTION

The present invention relates to an electrical device, which is configured to be connected electrically to external wires enclosed by an insulation material.

### BACKGROUND OF THE INVENTION

Suitable measures are to be provided for in order to connect the internal terminals of an electrical device to external wires. The wires may be part of a communication line of a network and run e.g. in a channel of a rail on which the electrical device is mounted. It is known to use additional connectors, wires or the like to make such a connection. However, such means make it difficult to arrange the electrical device in a definite position in relation to the wires.

### SUMMARY OF THE INVENTION

It is an aim of the present invention to provide for an electrical device, which is suitable to be connected to external wires such that the position of the electrical device relative to the wires can be chosen in a flexible manner.

This aim is achieved by an electrical device, which comprises pins for piercing the insulation material of the external wires and contacting them. By arranging the pins movably in relation to the internal terminals of the electrical device, it is possible to move the electrical device along the wires and to contact them, when the electrical device is at the desired position.

### BRIEF DESCRIPTION OF THE DRAWINGS

The invention is explained in the following by means of an exemplary embodiment with reference to Figures. In the drawings:

FIG. 1 shows a perspective view of a network component according to the invention, wherein part of the housing is removed;

FIG. 2 shows an explosive view of the network component according to FIG. 1;

FIG. 3 shows a sectional side view of the network component according to FIG. 1, wherein the housing is not removed;

FIG. 3A shows a detailed view of the encircled part in FIG. 3; and

FIG. 4 shows the network component of FIG. 3 with an additional control device.

### DETAILED DESCRIPTION OF THE PREFERRED EMBODIMENTS

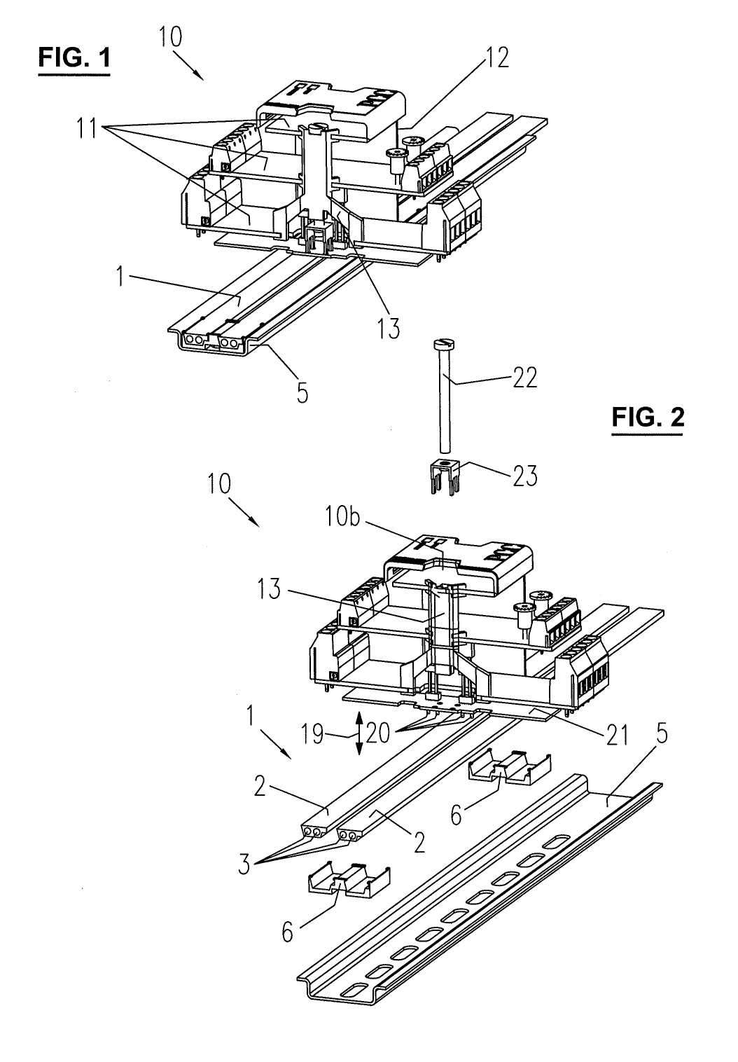

FIGS. 1 and 2 show a network component, i.e. a part of a network comprising a communication line 1 and a control device 10. The communication line 1 serves for exchanging signals among different control devices and may be configured as a bus (e.g. Profibus, CAN-bus, EIB, etc.), ethernet or in the form of any other line suitable for communication. In the embodiment shown here the communication line 1 comprises two cables. Each cable comprises an insulation jacket 2 which encloses two wires 3 and has an upper and a lower surface, which are substantially flat.

The communication line 1 runs in a channel of a mounting rail 5. The mounting rail 5 is e.g. a rail according to the norm “EN 60715 DA 38” or any other rail suitable for carrying a communication line 1 and control devices. The mounting rail 5 shown here comprises lateral wings which are arranged adjacent to the channel and holes formed in the channel for attaching the mounting rail 5 to a mounting surface, e.g. a wall, by means of screws or the like.

Cable holders 6 which hold the cables 2 are arranged successively in the channel of the mounting rail 5. The cable holders 6 serve for defining the lateral position of the wires 3 within the mounting rail 5. Instead of providing separate cable holders 6 or in addition to such cable holders 6, it is conceivable to shape the outer form of communication line 1 such that suitable elements for holding it in the mounting rail 5 are integrated in the insulation jacket 2.

The detailed construction of the control device 10 depends on its specific application. In the embodiment shown in FIGS. 1 and 2, the control device 10 comprises three plates 11, which are arranged on top of each other and which carry other electrical components, in particular electronic elements such as one or more microprocessors, one or more memory devices, potentiometers, terminals (e.g. clamped connections), displays, etc. A plate 11 may be configured for instance in the form of a printed circuit board (“PCB”). The lateral sides of each plate 11 is attached to a vertical plate 12 and to a holding part 13.

The control device 10 can be any electrical device which is adapted to transmit and/or to receive signals via the communication line 1. The signals are e.g. control signals and/or represent data. The control device 10 is in particular a device for automation and/or energy applications. Examples of the control device 10 are as follows:
Devices for conducting, transforming, accumulating, regulating, measuring and/or controlling electricity, e.g. electronic timers, energy meters, programmable logic controllers, electric control panels, relays, etc.
Electrical devices for energy management and/or energy savings, e.g. energy controllers, energy managers, energy loggers, displays, etc.
Electrical devices for automation, e.g. controllers in particular for electrical cabinets, touch screens, displays, HMI (“Human Machine Interface”) or other devices for machine and/or process automation, control and/or information units in particular for a building and/or a room, etc.

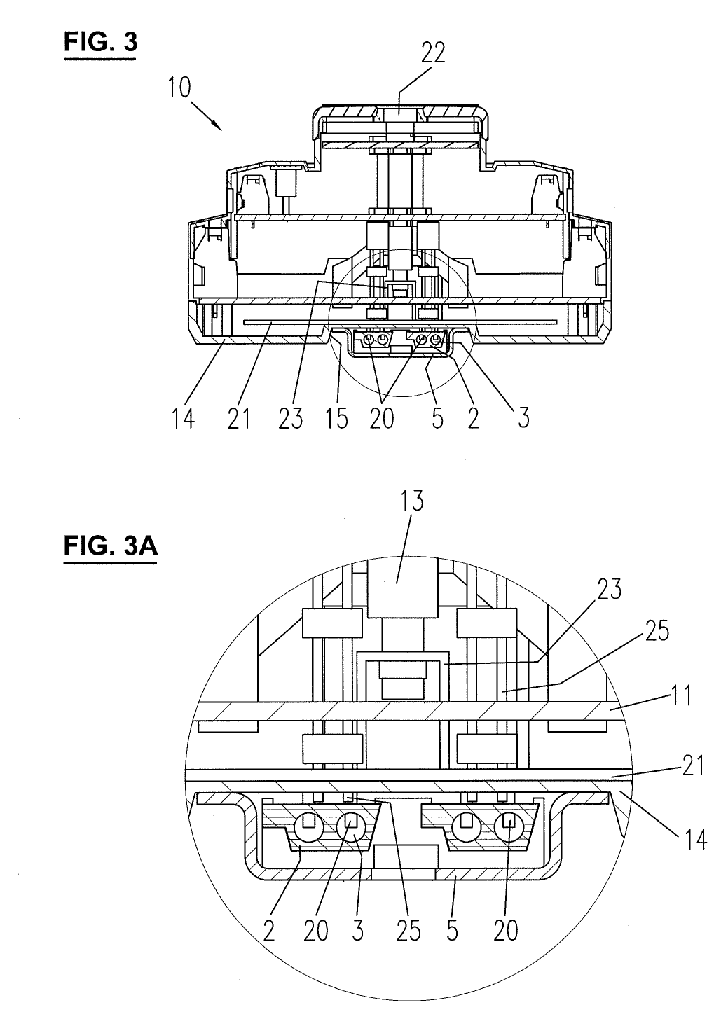

As can also be seen in FIGS. 3 and 3a, the control device 10 comprises pins 20 which project from the mounting side 14 of the control device 10, which is mounted on the mounting rail 5. The pins 20 are connected e.g. to one of the plates 11, from where the internal electric connections to the electrical components of the control device 10 are made. One of the plates 11 forms e.g. the main PCB.

The pins 20 are adapted to pierce the insulation jacket 2 for contacting the wires 3. For this purpose, the end of each pin 20 is substantially straight and has a pointed form. The distance between the pins 20 and their length are chosen in correspondence to the distance between the wires 3 and to the dimension of the insulation jacket 2.

The mounting side 14 of the control device 10 is configured such that it can be releasably attached to the mounting rail 5. In the present embodiment shown in FIG. 3, the mounting side 14 has a recess 15 which is adapted to receive the mounting rail 5. The control device 10 may be provided with one or more suitable attachment elements for attaching releasably the control device 10 to the mounting rail 5. Such an attachment element may be e.g. in the form of a movable lever, such that, after attachment, a wing portion of the mounting rail 5 is held between the lever and the mounting side 14 of the control device 10.

The control device 10 can easily be connected to other control devices via the communication line 1 by mounting the control device 10 on the mounting rail 5, such that the pins 20 pierce the insulation jacket 2 and contact the wires 3. Since no additional wiring is needed to make the connection to the communication line 1, material and costs can be saved.

When required, the control device 10 can be removed from the mounting rail 5 again. The control device 10 and communication line 1 are configured such that mounting and dismounting can be done without interruption of the network (“Hot Swapping”). The material for the communication line 1 is chosen such that the holes, which are produced by the piercing pins 20, are closed by themselves when the control device 10 is removed from the mounting rail 5. This is achieved e.g. by choosing a soft, elastic material for the insulation jacket 2.

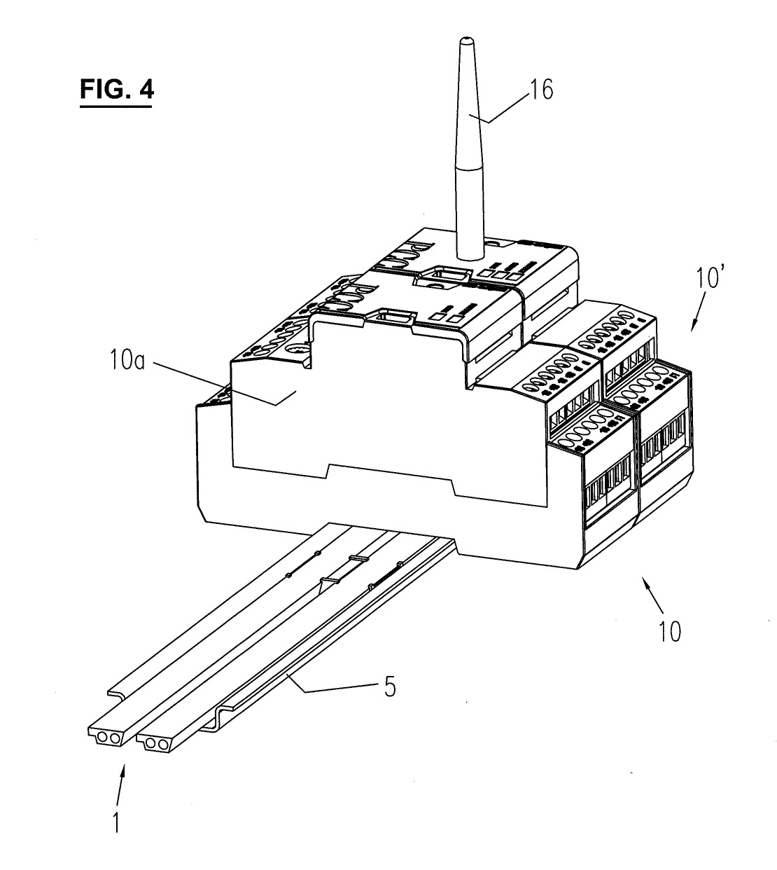

Another advantage is the saving of space as it is possible to position control devices close to each other on the mounting rail 5. FIG. 4 shows an example of another control device 10′ which is positioned adjacent to the control device 10. Each control device 10, 10′ has a housing whose lateral sides 10a are flat. The control device 10′ shown here has an antenna 16, which—in addition to the communication via the communication line 1—enables a wireless communication.

In order to move the control device 10 along the mounting rail 5 and to position it precisely at a required position, the pins 20 are arranged movably in relation to the mounting side 14 and the electrical components of the control device 10. As is indicated by the double arrow 19 in FIG. 2, the pins 20 are movable in the movement direction, which is arranged transversely to the direction in which the wires 3 extend.

As also can be seen in FIG. 3, the pins 20 are fixed to a movable plate 21. A screw 22 extends from the side which is opposite to the mounting side 14 through a hole in the holding part 13 and co-operates with the thread formed in a threaded element 23, which is fixed to the movable plate 21. The housing of the control device 10 has a recess 10b such that the end of the screw 22 is accessible to a user.

In order to establish the electrical contact between the pins 20, which are movable, and the fixed terminals of the control device 10, which the electrical components are connected to, intermediate pins 25 are provided for which extend from the rearward side of the movable plate 21. The forward ends of the intermediate pins 25 are in contact with the pins 20 and fixed to the movable plate 21 (cf. FIG. 3A). The rearward ends of the intermediate pins 25 are in sliding contact with the fixed terminals. Instead of using rigid intermediate pins 25 it is also conceivable to use flexible wires which connect the pins 20 with the fixed terminals of the control device 10.

Stops are provided for to define the distance of travel which the pins 20 can be moved. In the present embodiment, the holding part 13 serves as a first stop, which acts on the threaded element 23 when the pins 20 are moved away from the wires 3, and the inner part of the mounting side 14 serves as a second stop, which acts on the movable plate 21 when the pins 20 are moved towards the wires 3.

The first stop 13 defines the position of the pins 20 when retracted maximally and the second stop 14 defines the position of the pins 20 when extended maximally. The length of the pins and the stops 13, 14 are configured such that in the extended position the pins 20 do not go through the cable 2, 3, but ends therein, preferably within the wires 3 (cf. FIG. 3A).

Feedback means may be provided for to give the user an acoustic and/or haptic feedback when the pins 20 have reached a certain position. Such feedback means may comprise e.g. a stationary cantilever co-operating with the movable plate 21. The cantilever is bent when the plate 21 is moved towards the mounting rail 5 and—when the pins 20 are extended sufficiently—springs back which produces a specific sound.

The movable arrangement of the pins 20 allows the control device 10 to be placed at the desired position on the mounting rail 5 and to change the position if required. For mounting the control device 10, the pins 20 are positioned in the retracted position. The control device 10 is mounted on the mounting rail 5 and glided along the latter to the desired position. Then the screw 22 is screwed in such that the plate 21 and with it the pins 20 are moved towards the mounting rail 5. The pins 20 finally pierce the insulation jacket 2 and contact the wires 3. A reliable contact between the wires 3 and the pins 20 is given without the need of the provision of particular means producing a force on the pins 20.

If the control device 10 is to be moved to another position, the screw 22 is unscrewed such that the pins 20 are retracted and the control device 10 can be glided along the mounting rail 5 to the new position, where the pins 20 are again contacted with the wires 3 by screwing-in the screw 22.

From the preceding description, countless modifications are available to the expert without departing from the protective scope of the invention, which is defined by the claims.

The device 10, 10′ does not necessarily to be configured to exchange signals via a communication line and can be any electrical device which is to be connected to external wires, e.g. wires which are used for the supply of energy.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. An electrical device, being configured to be connected electrically to external wires, which are enclosed by an insulation material, the electrical device comprising
internal terminals for being connected to the external wires, and
pins for piercing the insulation material and contacting the external wires, the pins being arranged movably in relation to the internal terminals of the electrical device.

2. The device according to claim 1, further comprising a screwing mechanism for moving the pins.

3. The device according to claim 2, wherein the screwing mechanism comprises a screw, which extends in a moving direction of the pins.

4. The device according to claim 1, further comprising a movable plate, to which the pins are fixed.

5. The device according to claim 1, further comprising a connection, which is arranged between an end of at least one of the pins and at least one of the internal terminals, the connection is formed by a sliding contact or by a flexible internal wire.

6. The device according to according to claim 1, further comprising at least one of a first stopper to define a retracted position of the pins and a second stopper to define an extended position of the pins.

7. The device according to claim 1, further comprising a mounting part for removably mounting the device on a rail such that the device can be moved along the rail when the device is mounted thereon and the pins are in a retracted position.

8. The device according to claim 7, wherein the mounting part comprises a recess for receiving the rail, the recess being formed on a mounting side of the device.

9. The device according to claim 1, further comprising a housing with flat lateral sides.

10. The device according to claim 1, further comprising a printed circuit board, which comprises the internal terminals.

11. The device according to claim 1, the device being is configured to exchange signals via the external wires.

12. An electrical device, being configured to be connected electrically to external wires, which are enclosed by an insulation material and run in a channel of a mounting rail, the electrical device comprising:
internal terminals for being connected to the external wires,
pins for piercing the insulation material and contacting the external wires, the pins being arranged movably in relation to the internal terminals of the electrical device, and
a mounting part for removably mounting the electrical device on the mounting rail such that the electrical device can be moved along the mounting rail when the electrical device is mounted thereon and the pins are in a retracted position.

13. The device according to claim 12, further comprising a screwing mechanism for moving the pins.

14. The device according to claim 13, wherein the screwing mechanism comprises a screw, which extends in a moving direction of the pins.

15. The device according to claim 12, further comprising a movable plate, to which the pins are fixed.

16. The device according to claim 12, further comprising a connection, which is arranged between an end of at least one of the pins and at least one of the internal terminals, the connection is formed by a sliding contact or by a flexible internal wire.

17. The device according to according to claim 12, further comprising at least one of a first stopper to define the retracted position of the pins and a second stopper to define an extended position of the pins.

18. The device according to claim 12, wherein the mounting part comprises a recess for receiving the mounting rail, the recess being formed on a mounting side of the device.

19. The device according to claim 12, further comprising a housing with flat lateral sides.

20. The device according to claim 12, further comprising a printed circuit board, which comprises the internal terminals.

21. The device according to claim 12, the device being configured to exchange signals via the external wires.

22. A network comprising at least one electrical device according to claim 1.

23. A network comprising at least one electrical device according to claim 12.
